(19) United States
(12) Patent Application Publication
(10) Pub. No.: US 2008/0182074 A1
(43) Pub. Date: Jul. 31, 2008

(54) RIGID PVC MELT BONDED THERMOPLASTIC ELASTOMER COMPOSITES

(75) Inventors: Anthony Joseph Pasquale, Jonesborough, TN (US); Robert Dean Banning, St. Louis, MO (US)

Correspondence Address: TAMMYE TAYLOR, EASTMAN CHEMICAL COMPANY, 100 N. EASTMAN RD., KINGSPORT, TN, 37660-5075, US

(73) Assignee: EASTMAN CHEMICAL COMPANY, Kingsport, TN (US)

(21) Appl. No.: 12/021,350

(22) Filed: Jan. 29, 2008

Related U.S. Application Data
(60) Provisional application No. 60/898,490, filed on Jan. 31, 2007.
(60) Provisional application No. 60/923,589, filed on Apr. 16, 2007.

(51) Int. Cl. B32B 3/26; B32B 9/04

(52) U.S. Cl. 428/159; 428/411.1; 428/317.1

(57) ABSTRACT

Rigid PVC melt bondable thermoplastic elastomer compositions are disclosed. The melt bonded composites made from these compositions have rigid vinyl chloride polymer layers extruded with thermoplastic elastomer layers or with foam thermoplastic elastomer layers. The composites may be used as PVC siding, backing and sealants for PVC siding; vinyl flooring, window and door fenestrations; PVC conveyor belt outer grip layers; window and door sliding seals; window and door water dams; and PVC pipe seals.

This application claims benefit of provisional application entitled, MELT BONDED PLASTIC ELASTOMER COMPOSITE, Ser. No. 60/898,490, filed Jan. 31, 2007, and provisional application entitled, MELT BONDED PLASTIC ELASTOMER COMPOSITES, Ser. No. 60/923,589, filed Apr. 16, 2007, which are incorporated by reference herein.

### BACKGROUND OF THE INVENTION

Rigid PVC-bondable thermoplastic elastomers are disclosed. The compositions provide thermoplastic elastomer layers melt bonded to rigid polyvinyl chloride layers. The composites are useful in sealing and various construction applications, and they can be widely employed in extrusion and injection molding processes.

### BRIEF SUMMARY OF THE INVENTION

Vinyl chloride polymers (PVC) are widely used in outdoor construction applications due to their combination of low cost and workability. However, limitations of PVC include brittleness, poor weatherability, poor durability, and low energy efficiency. Rubber impact modifiers and sealants can be used to improve the properties of PVC. However, it can be difficult to bond substrates such as wood, metal, or plastic to PVC and very few resins have the compatibility to be melt bonded with PVC. Therefore, adhesives are applied to form a bond between the PVC and other resins and rubbers to form laminates. However, this process can be labor intensive and may result in poor quality lamination.

U.S. Pat. No. 4,680,234 describes a flexible weather resistant film comprising a weather resistant layer of a blend of a vinyl chloride polymer and chlorinated polyethylene and a second layer comprising a normally solid thermoplastic adhesive. Improved performance is obtained when the first layer additionally comprises an interpolymer of ethylene and at least one carboxylic acid or ester thereof containing ethylenic unsaturation.

U.S. Pat. No. 5,143,772 describes a rubber shaped article having a finishing layer which comprises a main body of rubber shaped article made of EPDM, a finishing layer of a PVC composition formed on the main body, and an adhesive layer formed between the main body and the finishing layer, said adhesive layer comprising 40 to 80% by weight of NBR, 20 to 40% by weight of EPDM and 0 to 35% by weight of SBR; and a process for producing said rubber shaped article. The rubber shaped article of the present invention provides internal and external automotive trims having an improved decorative design, with high productivity.

U.S. Pat. No. 5,302,650 describes a vinyl chloride resin composition that comprises: a mixture composed of 10 to 97 wt % vinyl chloride resin and 3 to 90 wt % thermoplastic polyester elastomer; and 10 to 200 parts by weight of a plasticizer with respect to 100 parts by weight of said mixture, the molecular weight of said plasticizer being 500 to 5000. This vinyl chloride resin composition can be easily melt bonded to polycarbonate resins which conventionally cannot be readily melt bonded. Therefore, the composition can be widely used in extrusion molding and injection molding. Furthermore, as a high molecular weight plasticizer is employed as the plasticizing agent, the problem of cracks can be overcome. In addition, since the necessity of using the adhesive agent in the manufacturing process can be eliminated, the overall cost can be significantly reduced.

U.S. Pat. No. 5,334,450 describes a weatherable film for lamination to a non-weatherable substrate, including, for example a three-layer film structure including: at least one first surface layer of a weatherable polymer comprising (a) AES, ASA, SAN or mixtures thereof or (b) any of the polymers of (a) blended with PVC, CPE, aliphatic polyurethanes or saturated styrenic block copolymers; said layer having a 1 percent secant modulus of greater than about 150,000 psi; at least one second intermediate layer being a tie layer underlying the weatherable layer, said intermediate tie layer being adjacent to and adhered to the weatherable layer, said intermediate tie layer having a modulus of less than about 150,000 psi; said tie layer adherable to at least a third underlying layer; and at least one third layer underlying the tie layer, said third layer adjacent to and adhered to the tie layer said third layer having a modulus of less than about 150,000 psi.

U.S. Pat. No. 5,380,797 describes high impact strength polymer blends containing at least two two-phase or multiphase polymers P1 and P2, which in turn contain at least one toughening phase A1 or A2 and at least one hardness phase B1 or B2. B1 and B2 differ in chemical structure and are thermodynamically compatible with one another. The polymer blend optionally contains another thermoplastic polymer B′3 and/or another two-phase or multiphase polymer P4 contain at least one toughening phase A4 and at least one hardness phase B4, provided that B′3 and/or B4 are different from B1 and B2 and are thermodynamically compatible with B1 and B2.

U.S. Pat. No. 5,403,892 describes a dynamically vulcanized thermoplastic composition which comprises a polymer blend of (a) a thermoplastic olefinic resin, such as non-elastomeric ethylene vinyl acetate copolymer; (b) an elastomeric ethylene vinyl acetate copolymer having a relatively higher vinyl acetate content; and (c) a specified elastomeric copolymer, such as halobutyl rubber, EPDM, or a halogenated copolymer of a C.sub.4 to C.sub.7 isomonoolefin and a para-alkylstyrene. Halogenated polyethylene may also be incorporated in the composition. The dynamically vulcanized thermoplastic composition is suitable for adhesion to polyvinyl chloride.

U.S. Pat. No. 5,415,921 describes a laminate which is useful as a construction material. The laminate has a substrate layer which contains vinyl chloride polymer, a butadiene rubber graft copolymer, and has a superstrate layer which contains vinyl chloride polymer, butylacrylate rubber graft copolymer, and titanium dioxide. The superstrate layer protects the substrate layer from excessive exposure to ultraviolet light, heat and moisture, and thereby protects the substrate layer from weathering during outdoor use of the laminate as a material for siding, gutter systems, downspouts, shutters, window casings, and other exterior outdoor weather exposed building material applications.

U.S. Pat. No. 6,195,952 describes a composite interlocking vinyl or other veneer siding having an elongated insulating member bonded to a vinyl panel with a permanently flexible adhesive that is compatible with both vinyl and insulation material and does not harden. The insulating member is configured such that a front face of the insulating material exactly coincides with the profile of the front face of the vinyl member. The insulating member forms a shallow shelf at an upper edge of the insulating member and an adjacent insulating member forms another shelf to overlap the adjacent shallow shelf to form a shiplap seal when assembled. Horizontal and vertical edges of the vinyl siding and insulating member are configured to overlap when mounted.

U.S. Pat. No. 6,277,915 describes block chlorinated polyolefins that are disclosed as performance enhancer of high rubber graft copolymers or chlorinated polyethylenes impact modifier in PVC and/or CPVC resins. The block chlorinated polyolefins (e.g. block chlorinated polyethylene) provide good dispersion of the impact modifier particles in the matrix and better adhesion between the impact modifier and the PVC and/or CPVC interface, providing better physical properties such as impact strength as measured by Notched Izod than did the randomly chlorinated polyolefins, often used as processing aids and as impact modifiers in PVC or CPVC. The differences in properties achieved with block chlorinated polyolefins versus randomly chlorinated polyolefins are attributed to the individual blocks of the blocky polyolefin being compatible with either the impact modifier or the PVC/CPVC resulting in better adhesion between phases.

US 2005/0153122 describes high temperature weather resistant exterior building product articles. Articles, such as siding, siding trim, decking, fencing and roofing products are made with a CPVC layer and optionally an insulating layer attached to the CPVC layer. The products have a heat distortion temperature greater than 180.degree. F. and preferably greater than 205.degree. F. The articles can be made in dark colors and have sufficient temperature resistance to withstand direct sunlight in warm climates as well as reflective heat.

US 2005/0208247 describes a multi-layered pipe of arbitrary length and cross-section produced by co-extrusion of a segmented thermoplastic copolyester elastomer (COPE) outer body over the exterior surface of an annular tubular core of CPVC/PVC having a wall thickness, measured in the radial direction, in the range from about 0.95 mm (38 mils) to about 1.375 mm (55 mils). The COPE is cohesively bonded to the annular core coextensively with essentially the entire length of the pipe. Though the COPE is easily degraded in contact with water, and CPVC and blends of CPVC with less than 25% by weight of PVC are typically rigid when extruded as pipe, a laminated pipe of COPE and CPVC/PVC with the specified wall thickness and overall dimensions which in the laminated pipe satisfy an applicable plumbing code (SDR-11 in the U.S.) has essentially the same performance characteristics as commercially available CPVC pipe which is a monolayer and not a laminate.

None of the above patents involve the process of permanently melt bonding a thermoplastic elastomer to a rigid polyvinyl chloride composition. Thus there remains a need in the art to provide articles, composites, and laminates wherein thermoplastic elastomers are coextruded and permanently bonded to rigid polyvinyl chloride substrates.

### SUMMARY OF THE INVENTION

The present invention pertains to melt bonded multilayer composites comprising: (a) at least one layer of a thermoplastic elastomer composition comprising from about 50 to about 100 percent by weight of a thermoplastic elastomer based on the total weight of the composition, and from about 0 to about 50 percent by weight of an adhesion promoter based on the total weight of the composition; and (b) at least one layer of a rigid polyvinyl chloride polymer composition.

The present invention also pertains to melt bonded multilayer composites comprising: (a) a first layer comprising a thermoplastic elastomer composition from about 50 to about 100 percent by weight of a thermoplastic elastomer based on the total weight of the composition, and from about 0 to about 50 percent by weight of an adhesion promoter based on the total weight of the composition; (b) at least one tie layer between and bonding said first and second layers comprising an adhesive composition; and (c) a second layer comprising a rigid polyvinyl chloride polymer composition.

The present invention further pertains to melt bonded multilayer composites comprising: (a) a first layer of a foam thermoplastic elastomer composition comprising from about 50 to about 100 percent by weight of a thermoplastic elastomer based on the total weight of the composition, and from about 0 to about 50 percent by weight of an adhesion promoter based on the total weight of the composition; and (b) a second layer comprising a rigid polyvinyl chloride polymer composition.

### DETAILED DESCRIPTION OF THE DRAWINGS

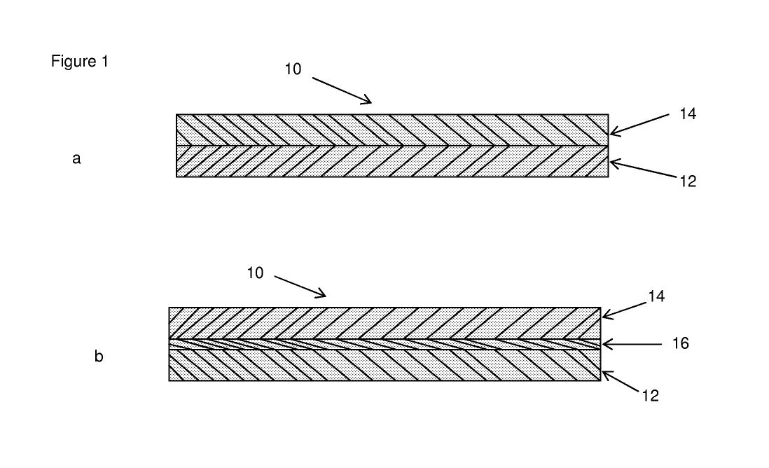

FIGS. 1(a) and (b) are illustrations of melt bonded composites in accordance with the present invention.

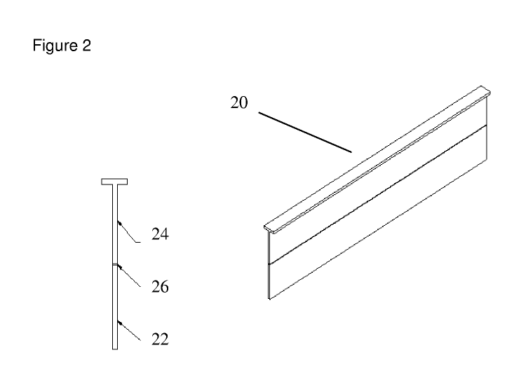

FIG. 2 is an illustration of a melt bonded die in accordance with the present invention.

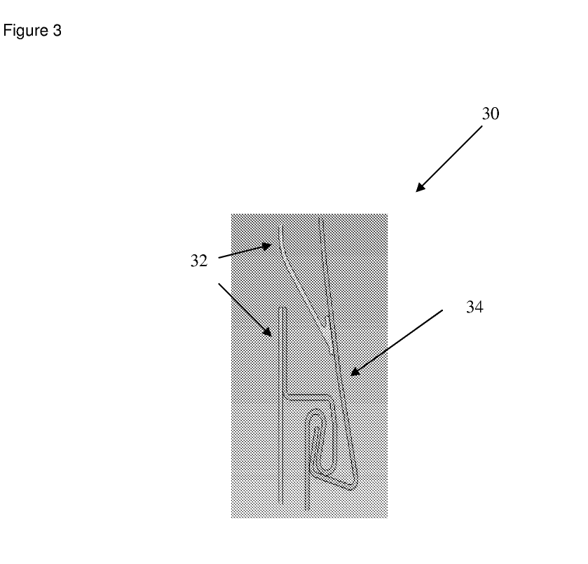

FIG. 3 is an illustration of a multilayer composite in accordance with the present invention in a building and construction application.

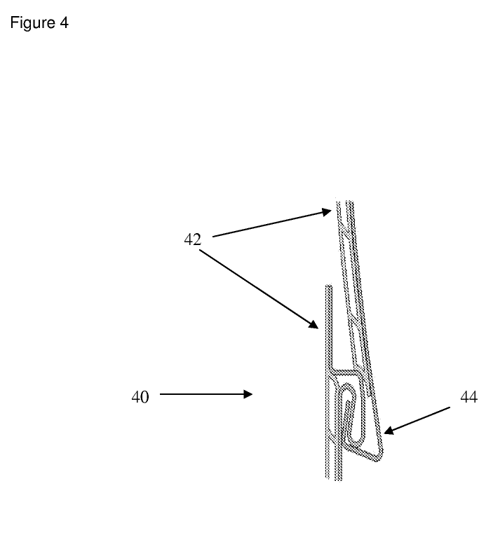

FIG. 4 is an illustration of a multilayer composite in accordance with the present invention in a building and construction application.

### DETAILED DESCRIPTION OF THE INVENTION

The present invention may be understood more readily by reference to the following detailed description of preferred embodiments of the invention and the Examples included therein.

Before the present compounds, compositions, articles, and/or methods are disclosed and described, it is to be understood that this invention is not limited to specific synthetic methods, specific processes, or to particular apparatuses, as such may, of course, vary. It is also to be understood that the terminology used herein is for the purpose of describing particular embodiments only and is not intended to be limiting.

In this specification and in the claims, which follow, reference will be made to a number of terms which shall be defined to have the following meanings.

As used in the specification and the appended claims, the singular forms “a,” “an” and “the” include plural referents unless the context clearly dictates otherwise. Thus, for example, reference to a polymer includes one or more polymers.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Optional” or “optionally” means that the subsequently described event or circumstance may or may not occur, and that the description includes instances where said event or circumstance occurs and instances where it does not. For example, the phrase “optionally heated” means that the material may or may not be heated and that such phrase includes both heated and unheated processes.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Throughout this application, where patents or publications are referenced, the disclosures of these references in their entireties are intended to be incorporated by reference into this application, in order to more fully describe the state of the art to which the invention pertains to the extent that they do not contradict the statements contained herein.

This present invention relates to thermoplastic elastomers melt bonded to rigid olefin substrates such as rigid polyvinyl chloride. In some embodiments of the present invention, the thermoplastic elastomers may contain adhesion promoters that are compatible with the rigid polyolefin substrates. Alternatively, in some embodiments, the thermoplastic elastomers may be extruded and permanently bonded to rigid polyvinyl chloride substrates using compatible tie layers. In other embodiments the thermoplastic elastomers are foam layers that may be extruded and permanently bonded to rigid polyvinyl chloride substrates.

For example, in one embodiment, as illustrated in FIG. 1(a), a melt bonded multilayer composite 10 is provided comprising at least one layer of a thermoplastic elastomer composition 12 which comprises a thermoplastic elastomer and an adhesion promoter and at least one layer of a rigid polyvinyl chloride polymer composition 14.

FIG. 1b illustrates a composite 10 in accordance with one embodiment of the present invention, including a TPE layer 12 melt bonded to a rigid PVC layer 14 and an optional tie layer 16.

The TPE layer 12 in accordance with the present invention comprises a TPE composition which includes a thermoplastic elastomer and an adhesion promoter. Suitably, any thermoplastic elastomer may used according to the present invention. For example, styrenic block copolymers (SBC) such as Kraton® (commercially available from Kraton Polymers) and Dynaflex® (commercially available from GLS Corporation) may be used as thermoplastic elastomers in the present invention. The suitable SBCs include, for example, styrene-butadiene-styrene (SBS), styrene-isoprene-styrene (SIS), styrene-ethylene-butylene-styrene (SEBS), and styrene-ethylene-propylene-styrene (SEPS). In addition, thermoplastic vulcanizates (TPV) such as Santoprene® (commercially available from ExxonMobil); copolyester elastomers (COPE) such as as PET (poly(ethylene terephthalate)) and PBT (poly(1,4-butylene terephthalate)) elastomers available commercially as Hytrel(R) from DuPont Company and Riteflex(R) from Ticona Company; or PCCE, cycloaliphatic polyesters, (copolymers of 1,4-cyclohexanedicarboxylic acid, 1,4-cyclohexanedimethanol, and polytetramethylene glycol), available commercially as Neostar® and Ecdel® from Eastman Chemical; polyolefin elastomers (POE) such as Engage® (commercially available from Dow Chemical), and thermoplastic urethane elastomers (TPU) such as Estane® (commercially available from Lubrizol Corporation), suitably may be used as thermoplastic elastomers according to the present invention. The thermoplastic elastomer compositions suitably may include any thermoplastic elastomers singly or a blend of one or more thermoplastic elastomers.

Any adhesion promoter would be suitable for use in the thermoplastic elastomer composition according to the present invention. The adhesion promoter may be any single adhesion promoter or it may be a blend of one or more adhesion promoters. Adhesion promoters that suitably may be used include, for example, maleated polyolefins; chlorinated polyolefins; maleated chlorinated polyolefins; acrylic polymers; ionic polymers; hydrocarbon resins, including aliphatic resins (C5), aromatic resins (C9), and cycloaliphatic resins (DCPD), such as Eastotac® (commercially available from Eastman Chemical); rosin and rosin derivative resins such as Permalyne and Poly-Pale® (commercially available from Eastman Chemical), terpene resins; low molecular weight resins such as Kristalex® and Regalrez® (commercially available from Eastman Chemical), ethylene-acrylate copolymers such as ethylene methyl acrylate copolymer (EMAC) or ethylene butyl acrylate copolymer (EBAC) (commercially available from Westlake), ethylene-vinyl acetate copolymers (EVA) such as Elvax® (commercially available from DuPont), and copolyester elastomers (COPE) such as Neostar® and Ecdel® (commercially available from Eastman Chemical).

Typically, the thermoplastic elastomer composition comprises from about 50 to about 100 percent by weight of the thermoplastic elastomer based on the total weight of the composition, and from about 0 to about 50 percent by weight of the adhesion promoter based on the total weight of the composition. For example, from about 75 to about 95 percent, or from about 80 to about 90 percent by weight of the thermoplastic elastomer based on the composition and from about 5 to about 25 percent, or from about 10 to about 20 percent by weight of the adhesion promoter based on the total weight of the composition.

Optionally, in one embodiment, a tie layer 16 is included between the TPE layer 12 and the PVC layer 14. The tie layer 16, which functions to tie or bond the PVC layer 14 to the TPE layer 12. In accordance with the present invention, the tie layer 16 comprises an adhesive composition. Generally, the adhesive composition may be any single adhesion promoter or it may be a blend of one or more adhesion promoters. Adhesion promoters that suitably may be used include, for example, maleated polyolefins; chlorinated polyolefins; maleated chlorinated polyolefins; acrylic polymers; ionic polymers; hydrocarbon resins, including aliphatic resins (C5), aromatic resins (C9), and cycloaliphatic resins (DCPD), such as Eastotac® (commercially available from Eastman Chemical); rosin and rosin derivative resins such as Permalyn® and Poly-Pale® (commercially available from Eastman Chemical), terpene resins; low molecular weight resins such as Kristalex® and Regalrez® (commercially available from Eastman Chemical), ethylene-acrylate copolymers such as ethylene methyl acrylate copolymer (EMAC) or ethylene butyl acrylate copolymer (EBAC) (commercially available from Westlake), ethylene-vinyl acetate copolymers (EVA) such as Elvax® (commercially available from DuPont), and copolyester elastomers (COPE) such as Neostar® and Ecdel® (commercially available from Eastman Chemical).

For example, in one embodiment, the adhesive composition may comprise a blend of from about 25 to about 75 weight percent of styrene block copolymers, from about 25 to about 75 weight percent of COPE, and from about 0 to about 5 weight percent polypropylene. In another embodiment, the adhesive composition may comprise a blend of from about 25 to about 75 weight percent of styrene block copolymer, from about 25 to about 75 weight percent of EVA, and from about 0 to about 5 weight percent polypropylene. In yet another embodiment, the adhesive composition may comprises a blend of from about 25 to about 75 weight percent of TPV, from about 25 to about 75 weight percent of EVA, and from about 0 to about 5 weight percent polypropylene. Additionally, in some embodiments, the tie layer 16 may comprise a blend of an adhesion promoter and a thermoplastic elastomer.

In the present invention, the multilayer composites 10 may have any desired thickness to suit the intended application. In one embodiment, the TPE layer 12 may have a thickness up to about 5.0 in, and the rigid PVC layer 14 may have a thickness up to about 5.0 in, and tie layer 16 may have a thickness up to about 0.2 in. For example, in some applications, the TPE layer 12 may have a thickness from about 0.05 in to about 5.0 in, and the rigid PVC layer 14 may have a thickness from about 0.05 in to about 5.0 in, and tie layer 16 may have a thickness from about 0.005 in to about 0.2 in. By further example, in other applications, the TPE layer 12 may have a thickness from about 0.05 in to about 1.0 in, and the rigid PVC layer 14 may have a thickness from about 0.05 in to about 1.0 in, and tie layer 16 may have a thickness from about 0.005 in to about 0.1 in.

In addition, the bond strength between the TPE layer 12 and the rigid PVC layer 14 may be selected to suit the intended application. Optionally, in some applications, higher bond strengths may be obtained with the inclusion of a tie layer 16. For example, in some embodiments, the bond strength between the TPE layer 12 and the rigid PVC layer 14 is greater than about 5 pli (pounds per linear inch). In some embodiments, the bond strength is up to about 10 pli. In other embodiments, the bond strength between the TPE layer and the rigid PVC layer is from about 5 pli to about 10 pli.

One embodiment of the present invention, as illustrated in FIG. 3, relates to an extruded multilayer composite 30 comprising: a first layer 32 comprising a foam thermoplastic elastomer composition; and a second layer 34 comprising a polyvinyl chloride polymer composition. Optionally in some embodiments, a tie layer, as previously described, may be included. Further, FIG. 4 illustrates a composite 40 in accordance with one embodiment of the present invention, including a foamed TPE layer 42 melt bonded to a rigid PVC layer 44 as an article in a building and construction application.

For example, one embodiment comprises a melt bonded multilayer composite with a first layer 32 or 42 of a foam thermoplastic elastomer composition comprising from about 50 to about 100 percent by weight of a thermoplastic elastomer based on the total weight of the composition, and from about 0 to about 50 percent by weight of an adhesion promoter based on the total weight of the composition; and a second layer 34 or 44 comprising a rigid polyvinyl chloride polymer composition.

In accordance with one embodiment of the present invention, a composite 30 or 40 comprises a first layer 32 or 42 of a foam thermoplastic elastomer composition melt bonded to a rigid PVC layer 34 or 44. The foamed thermoplastic elastomer typically comprises a thermoplastic elastomer and an adhesion promoter. Suitably any thermoplastic elastomer and any adhesion promoter previously described would be suitable for use. For example, suitable thermoplastic elastomers include copolyester elastomers (COPE) such as PET (poly(ethylene terephthalate)) and PBT (poly(1,4-butylene terephthalate)) elastomers available commercially as Hytrel(R) from DuPont Company and Riteflex(R) from Ticona Company) or PCCE cycloaliphatic polyesters, (copolymers of 1,4-cyclohexanedicarboxylic acid, 1,4-cyclohexanedimethanol, and polytetramethylene glycol), available commercially as Neostar® and Ecdel® from Eastman Chemical.

The thermoplastic elastomer foam layer 32 or 42 may be foamed using any conventional method. Any conventional chemical or physical blowing agents may be used. Preferably, the blowing agent is a physical blowing agent such as carbon dioxide, ethane, propane, n-butane, isobutane, pentane, hexane, butadiene, acetone, methylene chloride, any of the chlorofluorocarbons, hydrochlorofluorocarbons, or hydrofluorocarbons, as well as mixtures of the foregoing.

The blowing agent may be mixed with the thermoplastic elastomer in any desired amount to achieve a desired degree of expansion in the resultant foam. Generally, the blowing agent may be added to the thermoplastic elastomer in an amount ranging from about 0.5 to 80 parts by weight, based on 100 parts by weight of the thermoplastic elastomer. More preferably, the blowing agent is present at an amount ranging from 1 to 30 and, most preferably, from 2 to 15 parts per 100 parts by weight of the thermoplastic elastomer.

The foam layer 32 or 42 may have any desired thickness to suit the intended application. For example, in one embodiment, the foam layer may have a thickness up to about 5 inches. By further example the foam layer may have a thickness from about 0.05 inches to about 5 inches. The foam may have any desired density. For example, the density may range from about 1 to about 30 pounds/ft.sup.3. The foam sheet preferably has at least about 50% closed cells, more preferably about 60% closed cells and, most preferably, at least about 70% closed cells.

If desired or necessary, various additives may also be included with the thermoplastic elastomer. For example, it may be desirable to include a nucleating agent (e.g., zinc oxide, zirconium oxide, silica, talc, etc.) and/or an aging modifier (e.g., a fatty acid ester, a fatty acid amide, a hydroxyl amide, etc.). Other additives that may be included if desired are pigments, colorants, fillers, antioxidants, flame retardants, stabilizers, fragrances, odor masking agents, and the like.

Foam in accordance with the present invention is preferably made by an extrusion process that is well known in the art. Any conventional type of extruder may be used, e.g., single screw, double screw, and/or tandem extruders. In the extruder, the thermoplastic elastomers are melted and mixed. A blowing agent is added to the melted elastomers via one or more injection ports in the extruder. Any additives that are used may be added to the melted elastomer in the extruder and/or may be added with elastomer. The extruder pushes the entire melt mixture (melted elastomer, blowing agent, and any additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells.

For example, in one embodiment, PCCE (Neostar FN006) elastomer, as supplied by Eastman Chemical, was extruded at an approximate melt temperature from about 380° to about 395° F. with the use of Nitrogen foaming agent. The use of Nitrogen serves to reduce the density of the PCCE melt stream from about 0.1 to about 0.15 specific gravity. The reduction of specific gravity of the molten PCCE can be controlled by the rate of Nitrogen introduced into the melt stream with a highly accurate infusion pump.

Without being bound by any theory, the chemical PCCE to PVC bonding occurs via the heat of coextrusion at the interface between the PCCE and PVC held tightly under pressure within the land area of the die. The tool provides a gradual transition (via the machined steel path) to combine the intersecting surfaces of the PCCE and PVC in any design combination. The length to diameter (L/D) ratio for both materials creates the proper shear rate conditions to plasticate and melt each polymer. Typically, the compression ratio of the 24:1 L/D extruders is 2.5 to 1 (minimum). The materials are both fed individually into the screw/barrel combination with gravity fed hoppers to reach the back end of the screw. The cooling of the melt-coextruded PCCE to rigid PVC after the die is done via a combination of standard “cooling mists” supplied by spray heads and standard H₂O cooling tanks.

In general, the density (final specific gravity) of the Nitrogen foamed PCCE elastomer will be controlled via four primary factors:
1. Mass flow rate of Nitrogen into the PCCE melt stream
2. Melt temp of the PCCE
3. Shear rate of the PCCE
4. Specific die design incorporating proper land areas and expected swell of the foamed PCCE (just outside the die face).

In some embodiments the foam layer is a blend of PCCE with another type of polymer foamed by the above described method.

Any rigid polyvinyl chloride resin would be suitable for use in the present invention. Polyvinyl chloride polymers useful according to the invention include those described in “Vinyl Chloride Polymers” entry of Kirk-Othmer Encyclopedia of Chemical Technology, Vol. 24, 4th ed., (1997) pp. 1017-1053, which is incorporated herein by reference. For example, vinyl chloride resins such as homopolymers of vinyl chloride, copolymers of vinyl chloride and other vinyl monomers, halogenated compounds of their homopolymers, and alloys or blends with other plastics suitably may be used in the present invention. By further example, weatherable polyvinyl chloride (PVC), such Duracap® and Geon® (commercially available from PolyOne) may be used in the rigid polyolefin layer.

In addition, PVC polymers useful according to the invention include homopolymers of vinyl chloride and those vinyl chloride polymer resins having at least 70 wt. % repeating units polymerized from a vinyl chloride monomer, or at least 80 wt. %, or at least 90 wt. %, or even 95 wt. % or more of repeating units polymerized from a vinyl chloride monomer.

The polyvinyl chloride compositions of the invention may comprise repeating units polymerized from a vinyl chloride monomer, and may also include comonomers up to 30 weight percent of the copolymer from, without limitation, one or more of: the esters of acrylic acid, for example, methyl acrylate, ethyl acrylate, butyl acrylate, octyl acrylate, cyanoethyl acrylate, and the like; vinyl esters such as vinyl acetate and vinyl propionate; esters of methacrylic acid, such as methyl methacrylate, ethyl methacrylate, hydroxyethyl acrylate, butyl methacrylate, and the like; nitriles, such as acrylonitrile and methacrylonitrile; acrylamides, such as methyl acrylamide, N-methylol acrylamide, N-butoxy methacrylamide, and the like; halogen containing vinyl monomers such as vinylidene chloride, vinylidene fluoride, and vinyl bromide; vinyl ethers such as ethylvinyl ether, chloroethyl vinyl ether and the like; the vinyl ketones, styrene derivatives including .alpha.-methyl styrene, vinyl toluene, chlorostyrene; vinyl naphthalene; olefins such as ethylene, butene, isobutylene, propylene and hexene; and other copolymerizable monomers or mixtures of monomers having suitable reactivity ratios with vinyl chloride and known to those skilled in the art.

Some embodiments of the present invention may employ PVC blends with crosslinked PVC or crosslinked PVC alone. Crosslinked PVC polymers can be made by polymerizing vinyl chloride in the presence of cross-linking monomers such as the aforementioned diallyl phthalate, trimethylol propane triacrylate, allyl methacrylate, and the like, as taught in U.S. Pat. Nos. 4,755,699 and 5,248,546, the relevant portions of which are incorporated herein by reference.

The described homopolymers and copolymers are commercially available and may be produced by any suitable polymerization method including suspension, dispersion or blending. For example, polyvinyl chloride polymers prepared using suspension processes are suitable for use in the present invention.

When we say that the PVC compositions according to the invention are rigid we mean, for example, that the compositions are unmodified or unplasticized PVC that contains small amounts or no plasticizer. Whereas, flexible or plasticized PVC, typically may include plasticizers at levels greater than 12 phr. Thus, rigid PVC according to the present invention is characterized by a having a higher level of tensile strength than modified PVC compositions that are classified as flexible.

Also, according to the present invention rigid PVC refers to the property of a given compound having a certain tensile modulus. For example, PVC may be characterized as rigid when it has a tensile modulus that exceeds 10⁵ psi (or 689 MPa), and semirigid when its tensile modulus falls between 3×10³ and 10⁵ psi (20.7 MPa), and flexible when it has a tensile modulus that is less than 3×10³ psi (or 20.7 MPa) (the tensile modulus values are based on standard ASTM conditions of 23° C. and 50% relative humidity). Therefore, rigid PVC according to the present invention may have tensile modulus values that vary over a wide range, for example, the tensile modulus values may be from about 800 MPa to about 1000 MPa, or from about 1000 MPa up to about 2000 MPa or even up to 3000 MPa or greater.

The melt bonded multilayer composites according to the present invention may be produced by any conventional process using conventional methods including for example, extrusion, injection molding, calendaring, blow molding, rotational molding, or vacuum molding.

The melt bonded multilayer composites according to the present invention may be useful as articles in the following applications: building and construction, transportation including automotive and aviation, consumer goods, industrial equipment and machinery, appliance, apparel and accessories, sporting goods, appliances, packaging, health care, and electronics. For example, the melt bonded multilayer composites according to the present invention may be used to make articles for the following applications: backing and sealants for PVC siding; window and door fenestrations; PVC conveyor belt outer grip layer; window and door sliding seals; window and door water dams; and PVC pipe seals. Typically, articles made with composites of the present invention provide improved durability, energy efficiency, higher quality, improved weatherability including protection against heat, moisture, and ultraviolet light.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

Coextruded PVC/PCCE articles were prepared as follows:

### Materials:

Rigid layer: 100% Georgia Gulf 7181 Weatherable 7181 PVC
Flexible backing:

97.5% Eastman Neostar® FN007 PCCE Elastomer

2.5% Phoenix Plastics Cel-span 840 blowing agent

The following process conditions were used:

Rigid Layer: 3.5″ Davis Standard Thermatic extruder, L/D=24:1

330° F. for Zones 1-5

340° F. for Die Zone 1

360° F. for Die Zone 2

### Flexible Backing Layer: Berlyn 1″, L/D=24:1

360° F. for Zone 1

395° F. for Zone 2

410° F. for Zone 3

415° F. for Crossover pipe

440° F. for Die

The rigid die produced a wide PVC flat wall section with a nominal wall thickness of 0.050″, which closely mimicked a traditional residential vinyl siding cross section. The foamed flexible layer was extruded at a thickness of 0.250″. Pyncnometry was used to determine the foam level of the PCCE flexible layer to be 30% void density. The flexible foamed PCCE layer could not be peeled from the rigid PVC layer.

### Comparative Example 2

A comparative coextruded PVC/TPE article was produced according to the present invention employing a rigid PVC section and a flexible TPE section according to the following process and conditions:

### Materials:

Rigid layer: 100% Georgia Gulf 7181 Weatherable 7181 PVC
Flexible layer: 100% Santoprene 201-45 thermoplastic vulcanizate

The layers were coextruded and shaped using the die illustrated in FIG. 2. The die 20 in FIG. 2 has a rigid PVC layer 24, an adhesive layer 26 and a TPE layer 22. The tooling according to FIG. 2 was designed to be used with or without an optional tie layer. For Comparative Example 2 no tie layer was employed.

The following process conditions were used:

Rigid Layer: 3.5″ Davis Standard Thermatic extruder, L/D=24:1

330° F. for Zones 1-5

340° F. for Die Zone 1

360° F. for Die Zone 2

### Flexible Backing Layer: Berlyn 1″, L/D=24:1

345° F. for Zone 1

360° F. for Zone 2

365° F. for Zone 3

370° F. for Crossover pipe

370° F. for Die

### Comparative Example 3

Coextruded article was produced according to same procedure as Comparative Example 2. However, in Comparative Example 3 the TPE layer was 100% GLS Dynaflex G7960 SBS compound.

### Example 4

Coextruded PVC/TPE articles were produced according to the same procedure and composition as Comparative Example 2, but the TPE used in Example 4 was modified with 15 wt. % Eastman Eastotac 142W hydrocarbon resin. The modified TPV compound was melt blended using a Werner & Pfleiderer co-rating twin screw extruder, 30 mm diameter, 42″ length, 400° F. at 300 rpm.

### Example 5

Coextruded PVC/TPE articles were produced according to same procedure and composition as Comparative Example 2, but a tie layer was employed in example 5. The tie layer was composed 50 wt. % Kraton G-1660 SEBS, 45 wt. % Eastman Epolene G-3015 resin, and 5 wt. % Marlex 120 polypropylene. The tie layer compound was melt blended using a Werner & Pfleiderer co-rating twin screw extruder, 30 mm diameter, 42″ length, 400° F. at 300 rpm.

The bond strength of coextruded articles was measured using a 180° peel test using Instron tester according to ASTM D-3330 at 12 rpm. Results are summarized in Table 1. Reported values are the average of 5 measurements.

TABLE 1
180° Peel Strength.

| | Peel Strenth (psi) | s.d. |
|---|---|---|
| COMPARATIVE EXAMPLE 2 | no adhesion | N/A |
| COMPARATIVE EXAMPLE 3 | 7.6 | 2.7 |
| EXAMPLE 4 | 8.3 | 1.2 |
| EXAMPLE 5 | 11.3 | 2.4 |

As summarized in Table 1, TPEs modified according to the present invention exhibit improved melt bond strength with PVC composites formed via coextrusion. Furthermore, PCCE polyester thermoplastic elastomer formed melt bonded composites with PVC that produced bonds stronger than either substrate. The composite articles according to the present invention can be easily prepared via extrusion processes and widely used in a variety of applications.

The invention has been described in detail with particular reference to preferred embodiments thereof, but it will be understood that variations and modifications can be effected within the spirit and scope of the invention.

We claim:

1. A melt bonded multilayer composite comprising:
(a) at least one layer of a thermoplastic elastomer composition comprising
(i) from about 50 to about 100 percent by weight of a thermoplastic elastomer based on the total weight of the composition, and
(ii) from about 0 to about 50 percent by weight of an adhesion promoter based on the total weight of the composition; and
(b) at least one layer of a rigid polyvinyl chloride polymer composition.

2. A melt bonded multilayer composite comprising:
(a) a first layer comprising a thermoplastic elastomer composition
(i) from about 50 to about 100 percent by weight of a thermoplastic elastomer based on the total weight of the composition, and
(ii) from about 0 to about 50 percent by weight of an adhesion promoter based on the total weight of the composition;
(b) at least one tie layer between and bonding said first and second layers comprising an adhesive composition; and
(c) a second layer comprising a rigid polyvinyl chloride polymer composition.

3. A melt bonded multilayer composite comprising:
(a) a first layer of a foam thermoplastic elastomer composition comprising
(i) from about 50 to about 100 percent by weight of a thermoplastic elastomer based on the total weight of the composition, and
(ii) from about 0 to about 50 percent by weight of an adhesion promoter based on the total weight of the composition; and
(b) a second layer comprising a rigid polyvinyl chloride polymer composition.

4. The multilayer composite of claim 1, 2, or 3 wherein the thermoplastic elastomer composition comprises
(i) from about 80 to about 99 percent by weight of a thermoplastic elastomer based on the total weight of the composition, and
(ii) from about 1 to about 20 percent by weight of an adhesion promoter based on the total weight of the composition.

5. The multilayer composite of claim 1, 2, or 3 wherein the thermoplastic elastomer composition comprises
(i) from about 85 percent by weight of a thermoplastic elastomer based on the total weight of the composition, and
(ii) from about 15 percent by weight of an adhesion promoter based on the total weight of the composition; and

6. The multilayer composite of claim 1, 2, or 3, wherein the thermoplastic elasotmer is one or more of styrene block copolymers, thermoplastic vulcanizates (TPV), copolyester elastomers (COPE), polyolefin elastomers (POE), or thermoplastic urethane elastomers(TPU).

7. The multilayer composite of claim 6, wherein the styrene block copolymers are one or more of styrene-butadiene-styrene (SBS), styrene-isoprene-styrene (SIS), styrene-ethylene-butylene-styrene (SEBS), or styrene-ethylene-propylene-styrene (SEPS).

8. The multilayer composite of claim 6, wherein the thermoplastic vulcanizates are one or more of polypropylene or ethylene propylene diene monomer rubber.

9. The multilayer composite of claim 3, wherein the foam thermoplastic composition comprises copolyester elastomers (COPE) such as PET (poly(ethylene terephthalate)), PBT (poly(1,4-butylene terephthalate)) elastomers, or PCCE (cycloaliphatic polyesters).

10. The multilayer composite of claim 3, further comprising at least one tie layer between and bonding said first and second layers comprising an adhesive composition.

11. The multilayer composite of claim 1, 2 or 3, wherein the adhesion promoter is one or more of maleated polyolefins; chlorinated polyolefins; maleated chlorinated polyolefins; acrylic polymers; ionic polymers; ethylene-acrylate copolymers such as ethylene methyl acrylate copolymer (EMAC) and ethylene butyl acrylate copolymer (EBAC); hydrocarbon resins such as aliphatic resins (C5), aromatic resins (C9), or cycloaliphatic resins (DCPD); rosin and rosin derivative resins; terpene resins; low molecular weight resins; ethylene-vinyl acetate copolymers (EVA); or copolyester elastomers (COPE).

12. The multilayer composite of claim 2 or 10, wherein the adhesive composition comprises one or more of maleated polyolefins; chlorinated polyolefins; maleated chlorinated polyolefins; acrylic polymers; ionic polymers; ethylene-acrylate copolymers such as ethylene methyl acrylate copolymer (EMAC) and ethylene butyl acrylate copolymer (EBAC); hydrocarbon resins such as aliphatic resins (C5), aromatic resins (C9), or cycloaliphatic resins (DCPD); rosin and rosin derivative resins; terpene resins; low molecular weight resins; ethylene-vinyl acetate copolymers (EVA); or copolyester elastomers (COPE).

13. The multilayer composite of claim 2 or 10, wherein the adhesive composition is one or more of ethylene-vinyl acetate copolymers (EVA) or copolyester elastomers (COPE).

14. The multilayer composite of claim 2 or 10, wherein the adhesive composition comprises a blend from about 25 to about 75 weight percent of styrene block copolymers, from about 25 to about 75 weight percent of COPE, and from about 0 to about 5 weight percent polypropylene.

15. The multilayer composite of claim 2 or 10, wherein the adhesive composition comprises a blend from about 25 to about 75 weight percent of styrene block copolymer, from about 25 to about 75 weight percent of EVA, and from about 0 to about 5 weight percent polypropylene.

16. The multilayer composite of claim 2 or 10, wherein the adhesive composition comprises a blend from about 25 to about 75 weight percent of TPV, from about 25 to about 75 weight percent of EVA, and from about 0 to about 5 weight percent polypropylene.

17. The multilayer composite of claim 2 or 10, wherein the adhesive composition comprises a blend of an adhesion promoter and a thermoplastic elastomer.

18. The multilayer composite of claim 2 or 3 wherein the thickness of the first layer is up to about 5.0 in and the thickness of the second layer is up to about 5.0 in.

19. The multilayer composite of claim 2 or 3 wherein the thickness of the first layer is from about 0.05 in to about 5.0 in and the thickness of the second layer is from about 0.05 in to about 5.0 in.

20. The multilayer composite of claim 2 or 3 wherein the thickness of the first layer is from about 0.05 in to about 1.0 in and the thickness of the second layer is from about 0.05 in to about 1.0 in.

21. The multilayer composite of claim 2 or 10 wherein the thickness of the tie layer is from about 0.005 in to about 0.1 in.

22. The multilayer composite of claim 2 or 10 wherein the thickness of the tie layer is from about 0.005 in to about 0.2 in.

23. The multilayer composite of claim 2 or 10 wherein the thickness of the tie layer is up to about 0.2 in.

24. The multilayer composite of claim 2 or 3, wherein the bond strength between said first and second layers is greater than about 5 pli.

25. The multilayer composite of claim 2 or 3, wherein the bond strength between said first and second layers is up to about 10 pli.

26. The multilayer composite article of claim 2 or 3, wherein the bond strength between said first and second layers is from about 5 pli to about 10 pli.

27. An article comprising the multilayer composite of claim 1, 2, or 3.

28. The multilayer composite of claim 1, 2, or 3, wherein the composite is used to make articles in the following applications: backing and sealants for PVC siding; window and door fenestrations; PVC conveyor belt outer grip layer; window and door sliding seals; window and door water dams; PVC pipe seals.

29. The melt bonded multilayer composite of claim 1, 2, or 3, wherein the composite is used to make articles in the following applications: building and construction, transportation including automotive and aviation, consumer goods, industrial equipment and machinery, appliance, apparel and accessories, sporting goods, appliances, packaging, health care, or electronics.

30. The melt bonded multilayer composite of claim 1, 2, or 3, wherein the composite is melt bonded using one or more of the following processes: extrusion, injection molding, calendaring, blow molding, rotational molding, or vacuum molding.

31. A process for melt bonding the multilayer composite according to claim 1, 2, or 3.
